(19) United States
(12) Patent Application Publication
(10) Pub. No.: US 2015/0143209 A1
(43) Pub. Date: May 21, 2015

(54) SYSTEM AND METHOD FOR PERSONALIZING DIGITAL CONTENT

(71) Applicant: PlayMeBook Ltd., Tel Aviv (IL)

(72) Inventor: Gil SUDAI, Tel Aviv (IL)

(73) Assignee: PlayMeBook Ltd., Tel Aviv (IL)

(21) Appl. No.: 14/082,232

(22) Filed: Nov. 18, 2013

(51) Int. Cl. G06F 17/24

(52) U.S. Cl. CPC G06F 17/24
USPC 715/202

(57) ABSTRACT

A system and method for generating a personalized electronic book (e-book) include receiving a digital user visual content object from a user, obtaining a template e-book, the template e-book including at least one digital e-book content object and generating a personalized e-book by replacing at least a portion of the digital e-book content object with the digital user visual content object in at least some of the plurality of pages. The user visual content object may be an image of a face of the user.

### FIELD OF THE INVENTION

The present invention is in the field of electronic content. In particular, the present invention is related to personalizing electronic books or personalizing other digital content or media.

### BACKGROUND OF THE INVENTION

The electronic books industry offers a new experience for reading books. Electronic books (e-books) may include text, images and, in some cases, multimedia content such video clips, audio content and/or animated content. Some e-books are available in a text only format, other e-books include rich multimedia format.

However, current systems and methods do not enable automatically personalizing an e-book based on visual content provided by a user.

### SUMMARY OF EMBODIMENTS OF THE INVENTION

An embodiment of a method for generating a personalized electronic book (e-book) may include receiving a digital user visual content object from a user; obtaining a template e-book, the template e-book including at least one digital e-book content object, the digital e-book content object appearing in a plurality of pages included in the template e-book; and generating a personalized e-book by replacing at least a portion of the digital e-book content object with the digital user visual content object in at least some of the plurality of pages. The user visual content object may be an image of a face of a user. An embodiment of a method may include receiving from the user a marking of the face in an image and removing background information from the image to generate a modified image that only includes the face; and storing, on a server, the modified image of the face in association with an account of the user.

In an embodiment, a method may include using a template or input e-book that includes an indication of a location of a face of a character in an image included in the template e-book. An embodiment of a method may include replacing a face of the character with the face in the image according to the indication of a location. When used herein, a character is typically a representation of a participant or actor in a story, e.g., a person, an animal, a creature etc. For example, Cinderella and Pinocchio are characters in a story. A template e-book may include an indication of an orientation of a face of a character and replacing a content object in the template e-book with the digital user visual content object may include replacing a face of the character with the face in the image according to the orientation (e.g., when the user visual content object is an image of a face of the user). A character in a template e-book may be a headless character, and an embodiment of a method may include attaching the face of a user to the headless character based on a marking on the headless character.

A system according to one embodiment may store a plurality of modified images of the face of the user, and, based on a selection of the user, select one of the modified images for generating the personalized e-book. A system and method according to an embodiment of the invention may replace content in a template e-book with a drawing provided by the user. A system may obtain a plurality of images of faces of a respective plurality of people and generate a personalized e-book by replacing at least a portion of at least two different digital e-book content objects in a template e-book with at least two respective different images of faces selected from the plurality of images of faces.

A system and method according to an embodiment of the invention may include modifying a face in an image of a user based on an expression, the expression indicated in metadata associated with a template e-book. Modifying the face of a user in an image may include replacing face organs with other organs and/or modifying face organs. Modifying the face of a user in an image may be according to text included in a template e-book.

A system and method according to an embodiment of the invention may include receiving from the user a plurality of images of faces expressing a respective plurality of expressions, determining an expression of a character included in a template e-book and selecting to replace the face of the character with one of the plurality of faces based on the expression. A method may include replacing a portion of a face of a character in a template e-book with content received from the user.

An embodiment of a method may include generating a cartoon image based on an image of a face of the user and including a cartoon image in a personalized e-book. Generating a cartoon image based on an image of a face of the user may be based on a selection of a style. A selection of a cartoon style may be based on content or style in the template e-book. Generating a cartoon image of a user may be based on an identification of face organs in the image of a face of the user.

An embodiment of a method may include replacing an entire character in a template e-book with the image of the user. A user visual content object may be an image of an object and an embodiment of a method may include replacing an object in a template e-book with a user visual content object that includes an image of an object. User visual content object may be an image of a location. An embodiment of a method may include identifying a group of users related to a user based on social network information and enabling the group of users to share a personalized e-book. A system and method may include generating a personalized e-book for a first user based on an association of an image and a character in a story made by a second user.

A system and method according to an embodiment of the invention may include replacing the same digital e-book content object with a plurality of digital user visual content objects to generate a respective plurality of personalized e-books. A system and method according to an embodiment of the invention may include adding a character to a story in a template e-book by adding the digital user visual content object to the template e-book. Adding a character to a story in a template e-book may include receiving from a user a selection of a body of the character and receiving from the user a selection of a face of the character. Replacing content in a template e-book may include replacing text in the template e-book. A system and method according to an embodiment of the invention may include generating a personalized e-book by adding text to a template e-book.

A story in a template e-book may be designed for teaching mathematics, history, geography, the alphabet (“ABC”), a language and/or science. A template e-book may include multimedia content and user digital content may be used to replace a portion of the multimedia content to generate a personalized e-book. A personalized e-book may be broadcasted as a television program. A personalized e-book may be provided as a movie. A personalized e-book may be provided as an advertisement for a product or service. A personalized e-book may be provided on a digital billboard.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows high level block diagram of system according to embodiments of the present invention;

FIG. 2 shows a flowchart diagram illustrating a method for generating a personalized e-book according to some embodiments of the present invention;

FIG. 3A shows a page of a template e-book and user provided content according to embodiments of the invention;

FIG. 3B shows an exemplary page of an input or template e-book according to embodiments of the invention;

FIG. 3C shows an exemplary layer according to embodiments of the invention;

FIG. 3D shows a headless character in a layer according to embodiments of the invention;

FIG. 3E illustrates using a headless character according to embodiments of the invention;

FIG. 4 shows metadata according to embodiments of the invention;

FIG. 5 shows exemplary screenshots according to embodiments of the invention;

FIG. 6 shows an exemplary screenshot according to embodiments of the invention;

FIG. 7 shows exemplary screenshots according to embodiments of the invention;

FIG. 8 shows a high level block diagram of an exemplary computing device according to embodiments of the present invention; and

FIG. 9 shows a flowchart diagram illustrating a method for generating a personalized e-book according to some embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As described herein, a system and method according to embodiments of the invention enable personalizing an e-book (or other electronic content). As described, a system and method according to embodiments of the invention enable personalization of an e-book by personalizing specific or selected visual elements in an e-book. For example, by replacing the face of character (e.g., the hero) in an e-book, a reader or user may be made to feel as if she or he is a part of the e-book.

Although, for the sake of clarity and simplicity, e-books are mainly referred to herein, it will be understood that embodiments of the invention are not limited to e-books and that other electronic content may be personalized using embodiments of the invention. For example, advertising material, campaigns and the like may be personalized using embodiments of the invention. Accordingly, it will be understood that embodiments of the invention are relevant to any content published or used in the digital media market.

As described herein, a system and method according to embodiments of the invention may be used in personal publishing scenarios and/or as a platform that supports 3^{rd} party publishers. As described herein, a system and method according to embodiments of the invention may enable a personalized, rich experience by combining content in an e-book with content generated or obtained by a user, and providing the combined content, e.g., as a personalized e-book.

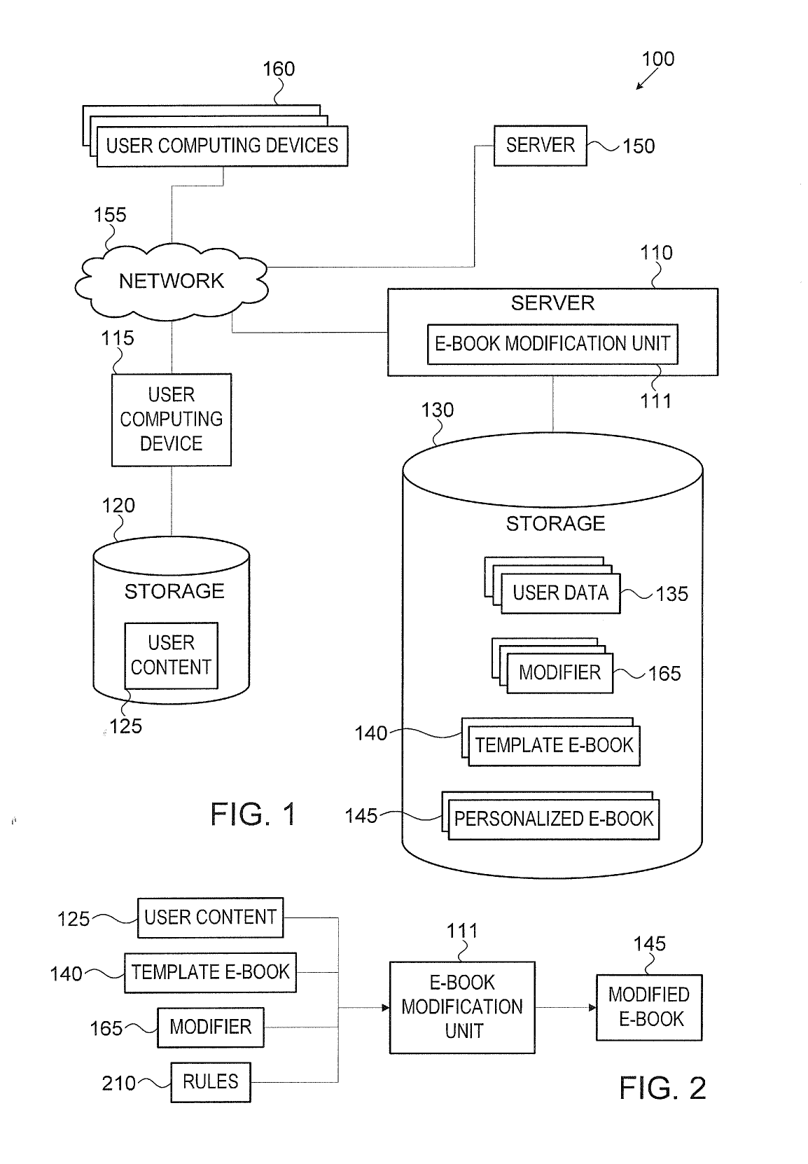

Reference is made to FIG. 1 which shows high level block diagram of system 100 according to embodiments of the present invention. As shown, system 100 may include a user computing device 115 operatively coupled to a storage 120. As shown, system 100 may include or be connected to a plurality of user computing devices 160. As further shown, system 100 may include a server 110 operatively connected to a storage 130. As shown, server 110 may include an e-book modification unit (EMU) 111. System 100 may include, or be connected to, additional servers, for example, system 100 may include server 150. As shown, system 100 may include a network 155. Servers 110 and 150 may be any suitable servers as known in the art, e.g., web servers, application servers or other suitable server computers. User computer device 115 and user computer devices 160 may be any suitable computing devices, e.g., a home computer, a personal or portable computer (PC) or a wireless or mobile computing device, e.g., a smartphone, mobile phone, tablet computer and the like. In an embodiment, EMU 111 is a controller and an executable code segment that is executed by the controller. For example, in an embodiment EMU 111 is controller 805 that executes executable code 825. For example, in an embodiment, server 110 is a computing device similar to computing device 800 that includes a memory 820, controller or controller 805 and executable code 825 and EMU 111 may be the processor 805 executing executable code 825 stored on the memory 820. For example, EMU 111 may be processor or controller 805 described with reference to FIG. 8 configured to carry out methods of the invention by, for example, executing executable code 825 stored in memory 820.

In an embodiment, EMU 111 may be or may include an application executed by server 110. EMU 111 may be any suitable unit or module. For example, in some embodiments, EMU 111 may be a dedicated or special hardware component, e.g., a card that includes an application-specific integrated circuit (ASIC) that may be installed in server 110 or any other suitable hardware or firmware. While EMU 111 is described as carrying out operations according to embodiments of the present invention, in some embodiments other units, such as server 110 and/or a processor such as processor 805 may carry out embodiments of the present invention; e.g., a dedicated EMU 111 need not be used.

Network 155 may be, may comprise or may be part of a private or public internet protocol (IP) network, or the internet, or a combination thereof. Additionally or alternatively, network 155 may be, comprise or be part of a global system for mobile communications (GSM) network. For example, network 155 may include or comprise an IP network such as the internet, a GSM related network and any equipment for bridging or otherwise connecting such networks as known in the art.

In addition, network 155 may be, may comprise or be part of an integrated services digital network (ISDN), a public switched telephone network (PSTN), a public or private data network, a local area network (LAN), a metropolitan area network (MAN), a wide area network (WAN), a wireline or wireless network, a satellite communication network, a cellular communication network, any combination of the preceding and/or any other suitable communication means. Accordingly, numerous elements of network 155 are implied but not shown, e.g., access points, base stations, communication satellites, GPS satellites, routers, telephone switches, etc. Accordingly, network 155 may enable components of system 100 to communicate as described herein. It will be recognized that embodiments of the invention are not limited by the nature of network 155.

Storage 120 and storage 130 may be any suitable storage units, devices or systems. Storage 120 and storage 130 may include or may be, for example, a hard disk drive, a Compact Disk (CD) drive, a CD-Recordable (CD-R) drive, or other suitable removable and/or fixed storage unit. Storage 120 and storage 130 may include or may be a USB storage device, network storage device or a FLASH storage device. It will be recognized that the scope of the present invention is not limited or otherwise affected by the type, nature, operational and/or design aspects of storage 120 and storage 130. For example, storage 120 and/or storage 130 may comprise any suitable number of possibly different storage devices without departing from the scope of the present invention.

As shown, storage 120 may include user content 125. For example, user content 125 may include digital user visual content objects. Digital user visual content objects may include any applicable visual content, e.g., images, illustrations or video clips. As described herein, user content 125 may be digital user visual content generated, produced, received or obtained by a user operating user device 115. For example, a user may download digital visual (or other) content from server 150 to user computing device 115, modify downloaded content and store the downloaded (and/or modified) content on storage 120 as shown by user content 125. The user may then upload the digital user visual content objects to server 110 where they may be used by EMU 111 to generate a personalized e-book as described herein.

In another case, user digital visual content 125 includes images obtained by a user, e.g., using his or her camera. As shown, storage 130 may include one or more user data items 135, one or more modifiers 165, one or more e-book templates 140 and one or more personalized e-books 145. User content 125 may be any visual or other digital information, e.g., files stored on storage 120. For example, user content 125 may include digital visual content such as digital images stored as Joint Photographic Experts Group (JPEG) or bitmap image file format (BMP) or it may include content stored as Portable Document Format (PDF), Extensible Markup Language (XML) and/or Hypertext Markup Language (HTML) files. User content 125 may be obtained using any suitable devices, systems or methods. For example, user content 125 may include digital images obtained by a user's camera or smartphone, user content 125 may include a digital scan of a drawing made by a user, user content 125 may include an output of a digital drawing tool or application or user content 125 may include content downloaded from the internet.

Reference is made to FIG. 2 which shows a high level block diagram of a flow according to embodiments of the invention. As shown, user content 125 may be provided to EMU 111. As shown, a template e-book 140 and a modifier 165 may be provided to EMU 111. As further shown, rules 210 may be provided to EMU 111. Provided with input as shown in FIG. 2, EMU 111 may process a template e-book and generate a modified e-book 145 as shown. For example, to produce modified e-book 145, EMU 111 extracts elements from user content 125 and inserts them into template e-book 140. In an embodiment, EMU 111 is provided with rules that govern the production of modified e-book 145 as shown by rules 210. In an embodiment, EMU 111 generates modified e-book 145 based on modifiers as shown by modifier 165. In an embodiment, EMU 111 provides the modified e-book 145 to a user. For example, EMU 111 provides modified e-book 145 to user computing device 115 over network 155 (e.g., as a PDF file) and the provided modified e-book 145 is presented to a user by user computing device 115. In other embodiments, e-book 145 is presented on the cloud, e.g., presented as web content using a web browser as known in the art. User content 125, template e-book 140, modifier 165 and rules 210 are further discussed herein.

User content 125 may be any suitable or applicable content. For example, user content 125 may include images of the user's face or body, images of the user's family members, images of the user personal objects (e.g., toys, clothes, room) and the like. User content 125 may include text, audio content or multimedia content. In an embodiment, user content 125 is stored as files on storage 120. For example, a user may take pictures using his or her camera and store the pictures as user content 125. User content may be content downloaded, e.g., from server 150 or from the internet. User content 125 may be uploaded to server 110 and stored as shown by user data 135. User content 125 may be stored after the user or the system performs modifications of the content, e.g., “cleaning” of the background or choosing a specific cartoon based on the user's face as further described herein.

User data 135 may be content provided (e.g., uploaded) by a user. User data 135 may include, in addition to content uploaded by a user, metadata. For example, when EMU 111 receives a content element (e.g., an image, an audio file or a multimedia object) from a user, EMU 111 associates the content element with an identification parameter and stores the content and the identification in user data 135. For example, user data 135 may include digital images stored as Joint Photographic Experts Group (JPEG) or bitmap image file format (BMP) or it may include content stored as Portable Document Format (PDF), Extensible Markup Language (XML) and/or Hypertext Markup Language (HTML) files.

Template e-book 140 may be an electronic book and may further include metadata as described herein. For example, metadata included in a template 140 may be an identification parameter as described herein. Personalized e-book 145 may be an e-book generated based on template e-book. For example, personalized e-book 145 may be generated by replacing items or objects in template e-book 140 with items or objects extracted from user content data 135. Modifier 165 may be used to generate personalized e-book 145. For example, a modifier may indicate a scene, a mood and the like.

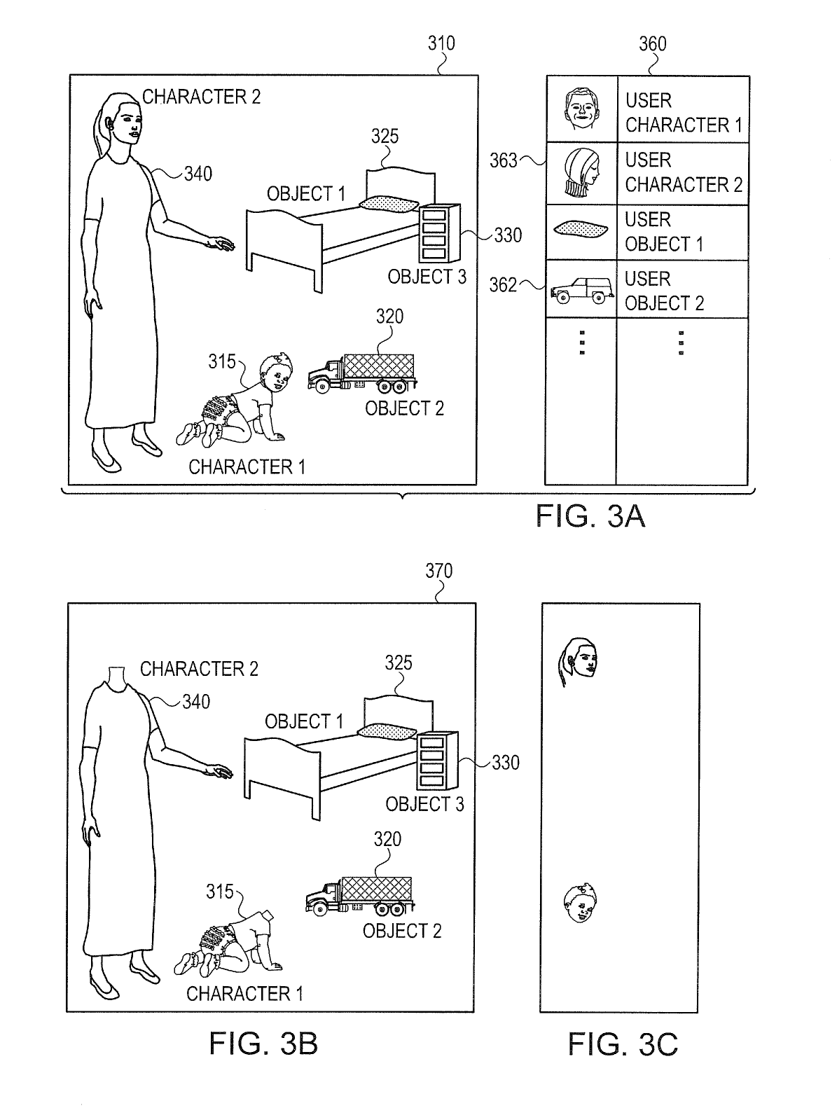

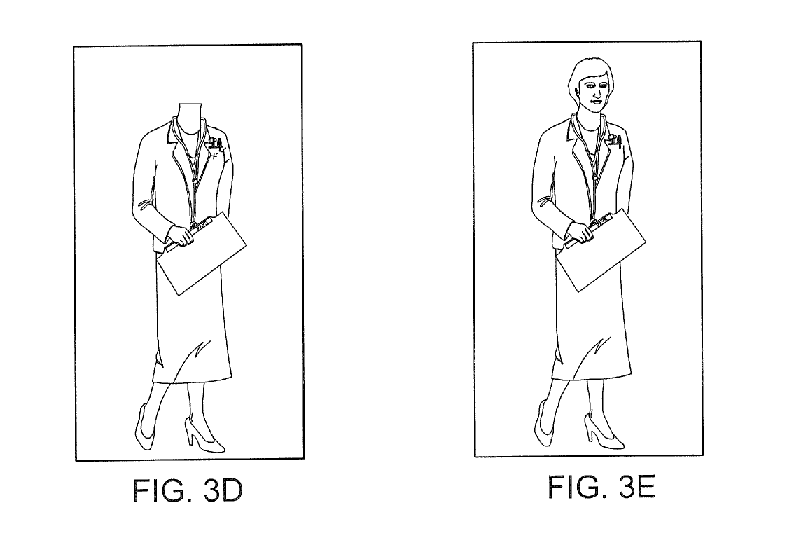

As described herein, to generate an e-book or to generate a modified e-book, an embodiment may replace elements or items in a template or other e-book with elements provided by a user. Reference is made to FIG. 3A that graphically illustrates a page of a template e-book and user provided content according to embodiments of the invention. As shown by page 310, a page in a template e-book may include template e-book content objects, items or elements and/or characters.

Template e-book content objects may be any objects or items, typically digitally stored objects. For example, in an embodiment, template e-book content objects are images. For example and as shown, a page in a template e-book may include images of a first character 315 (e.g., a child) and of a second character 340 that may be an adult. As further shown, a page in a template or input e-book may include template e-book objects such as an image of object 325 (a bed), an image of object 330 (a cupboard) and an image of object 320 (a toy truck). A page in a template e-book can also include other elements that may not personalized, e.g., a background or characters that are kept unchanged.

As shown by user provided content 360, user provided content may include digital user visual content objects, e.g., images of people, or, as shown, a picture of a face (or face and body) 361 and a picture of a person 363 and images of objects, e.g., pictures of a cup and a picture of a toy car 362 as shown. To generate a modified e-book, elements or characters in an input (or template) e-book may be replaced by user provided content. For example, the face of character 315 in a template e-book may be replaced by picture 361, character 340 may be replaced by user provided character 363 and/or object 320 may be replaced by user object 362. It will be understood that where applicable, when objects, elements or characters in a template and/or personalized e-book are discussed, images of these objects, elements or characters are referred to.

A template e-book content object may appear in a plurality of pages in the template e-book. For example, a hero or other character in an e-book may appear in a number of pages in the template e-book. As described herein, to generate a personalized e-book, a system or method according to embodiments of the invention may receive a digital user visual content object and automatically replace a template e-book content object appearing in a plurality of pages in the template e-book with the received digital user visual content object. For example, EMU 111 may receive, from a user, a digital user visual content object such as an image of a face of the user and replace the face of a template e-book content object such as an image of character. For example, exemplary received digital user visual content object are shown in FIG. 3a by user character 361, user character 362 and user character 363. Exemplary template e-book content objects are shown by characters 340, 315. Additional template e-book content object and digital user visual content objects are shown in FIG. 3A.

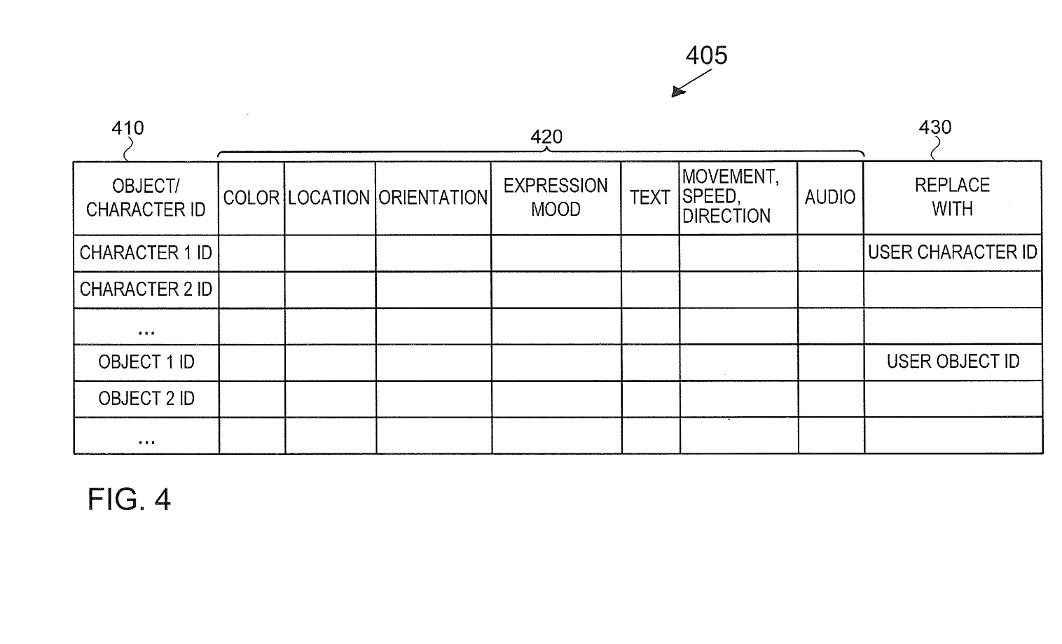

For example, if the image of the character appears in a number of pages in a template e-book, EMU 111 may replace the face of the character in each, or some, of the pages. As described herein, metadata for each page in a personalized e-book (or metadata associated with each page) may indicate for the page which object is to be replaced with user provided content. Accordingly, the same user provided content object (e.g., a digital user visual content object as shown, for example, by 361 in FIG. 3A) may be used to replace an object appearing in a plurality of pages of a template e-book by indicating, in metadata associated with each page that the user provided content is to replace the object appearing the page. Similarly, using metadata as described herein, the same object appearing twice, in a first and second pages of a template e-book may be replaced by a first user provided object in the first page and replaced by a second, different user provided content object in the second page. It will be understood that using metadata 405 (FIG. 4) as described herein, any replacement of any object in a template e-book with any user provided content may be enabled. Specifically, any graphical content in a template e-book may be replaced by user provided graphical or visual content.

For example, to generate a modified e-book 145, EMU 111 replaces the image of the toy track 320 in input or template e-book 140 (as shown by object image 320) with the image of the toy car 362 shown by user provided object 362. For example, toy car 362 is an image of an actual toy of a child for which a modified e-book is generated. Accordingly, a modified e-book generated by a system or method according to embodiments of the invention may be personalized by including, in the modified e-book, content which was provided by the user, e.g., images of toys of the user, images of family members etc. In another example, character image 340 in an input or template e-book 140 may be replaced by an image provided by a user to generate personalized e-book 145. For example, to personalize an e-book for a child, an image of an adult in a template e-book is replaced by an image of a parent of the child.

In an embodiment, a template or input e-book may include faceless or headless characters. Reference is additionally made to FIG. 3B that shows an exemplary page of an input or template e-book. As shown by page 370, characters 315 and 340 in a template e-book may be headless characters. As described herein, to generate a personalized e-book, an image of a face of a user may be placed or added such that headless characters in a template e-book will have the head or face of the user. For example, the center of the neck of headless characters 340 and 315 may be identified and/or marked and an image of a face of the user may be automatically placed based on the center of the neck. Accordingly, headless characters in a template e-book may be personalized by an addition or inclusion of an image of a head or face of the user. Reference is additionally made to FIGS. 3D and 3E that illustrate using headless characters in an embodiment. As shown by FIG. 3D, a headless character may be included in a template e-book. As shown by FIG. 3E, an image of a face of a user may be placed on the headless character such that the resulting character is personalized by having the face of a user.

In an embodiment, graphical content in a template e-book includes layers. For example, an illustrator that provides illustrations for a template e-book delivers illustrations or images that include layers. For example, a first layer includes the background of the illustration and the headless bodies of characters that may be personalized (referred to herein as the bodies layer) and a second layer includes the faces or heads that may be personalized (referred to herein as the faces layer). Generally, a layer may be any digital representation of elements that may be included in an image. An image may be generated or it may include a plurality of layers. For example, within an image, a first element (e.g., an image of a first person) may be included in a first layer and a second element (e.g., an image of a second person or an image of an object or a background) may be included in a second layer. To generate or present the complete image, two or more layers may be superimposed or otherwise combined such that the resulting image includes elements from all layers. In other embodiments, the content in a first layer may be overlaid on the content of a second layer such that an image that includes elements in both layers is produced.

For example, FIG. 3D is an example of a layer provided by an illustrator that only includes a body of a character and the background. Another layer that only includes the head of the character may be provided by the illustrator. Using layers as described herein may enable systems and methods according to embodiments of the invention to replace or place heads or faces from a first layer on a second layer such that the resulting image is optimized. For example, when placing an image of a user's face on a layer that includes a body and background, the resulting image may be an image wherein no boundaries are seen between the face of a character and the background since the image of the user's face covers some of the background.

Reference is additionally made to FIG. 3C that shows an exemplary layer according to embodiments of the invention. For example, FIG. 3B may be a first layer that includes headless characters 340 and 315 and FIG. 3C may be a second layer that includes faces for characters 340 and 315. For example, an illustrator may provide layers in the form of images as shown by FIG. 3B and FIG. 3C. The illustrator may further mark or provide an indication of the center of the neck of each character (e.g., characters 340 and 315) or the marking of the center of the neck can be done by the administrator who is managing the publishing of the personal e-book. In yet other embodiments, marking of a center of a neck of a character may be done automatically. For example, a software module (e.g., EMU 111) may automatically identify a neck of a character in an illustration or image and automatically mark the center of the neck. EMU 111 may use the marking or indication of a center of a neck in order to place or fit faces in one layer onto headless characters in another layer. For example, to generate page 310, EMU 111 may obtain faces from a layer as shown by FIG. 3C and connect the faces to headless characters in a layer as shown by FIG. 3B. For example, a template e-book may include layered images and, to generate a personalized e-book, EMU 111 may combine some of the content in a first layer with content in a second layer.

When presenting the template e-book, a system or method according to embodiments of the invention may generate the characters in the template e-book by overlaying layers or by merging layers. For example, to generate and/or present a template e-book, a system or method according to embodiments of the invention may place faces from the faces layer on the bodies in the bodies layer thus creating the complete characters. An end user may see or view an e-book (e.g., a template e-book or a personalized e-book) using for example a web browser. For example, an e-book may be provided and presented to a user using any methods known in the art for presenting graphical content. As known in the art, graphical, textual and other content stored on or generated by a server may be sent over a network and presented to a user using a web browser or a dedicated application. It will be understood that a template e-book and/or a personalized e-book may be provided and presented to a user using any method known in the art without departing from the scope of the invention.

Layers may be used when generating a personalized e-book. For example, if a page in a template e-book includes three characters, e.g., two children and an adult, and a user selects or provides commands or input to replace the face of one of the children with his own face, to generate the personalized e-book, a system or method according to embodiments of the invention may start with the layer that only has the bodies (the bodies layer) of the characters and place an image of the user's face such that it becomes the face of the selected child. The system or method according to embodiments of the invention may further obtain, from the faces layer, the faces of the characters who are not replaced by the user and place the faces obtained from the faces layer on the bodies layer. Accordingly, in this example, the resulting page will include the three characters where the face of one of the characters is replaced by the user's face and the faces of the other characters are as in the template e-book. As described herein, the bodies layer may include markers, e.g., a mark of a center of a neck. Any markers may be included in a layer such that automatic placement of heads or faces (e.g., obtained from a faces layer) may be facilitated.

Reference is made to FIG. 4 which graphically shows metadata 405 associated with, or included in, a template e-book. Metadata 405 may be associated with, or included in, a modified or a personalized e-book. In some embodiments, elements of metadata 405 may be included in user data 135. It will be understood that the structure and data elements shown in FIG. 4 are exemplary data and structure and that other data elements and/or data structures may be used in embodiments of the invention.

Generally, metadata 405 may be used to record any modification applied to a template e-book in order to generate a personalized e-book. For example, when a user selects or provides instructions to replace or modify an object (e.g., a face of a character) in a template e-book, an entry related to the object is modified. For example, if the user selects to replace a face of a character in a template e-book with an image of her face then an entry related to the face of the character is modified as described herein to record the replacement. Accordingly, any replacement may be enabled. For example, a face of a character appearing in a plurality of pages may be replaced in each page or in some of the pages based on user selection since user selection may be recorded separately for each page in a separate metadata object associated with each page. If the user selects to replace a face of a character throughout an e-book then an embodiment may automatically modify all entries in all pages where the character appears such that the replacement is global or applied to the entire e-book. Any combinations may be supported. For example, if a character appears twice in a page of a template e-book then two entries in metadata associated with the page may each be modified separately such that two different user content objects may be used to replace or modify the two instances of the character appearing in the same page.

As shown by column 410, metadata 405 may include an identification of elements in a template (or input) e-book. For example, an entry in column 410 (e.g., “character 1 ID”) may be an identification parameter (e.g., a value such as “100”) that may identify, or be associated with, a character in a template (or input) e-book, e.g., character 340 in FIG. 3A. Similarly, “character 2 ID” in column 410 may be an identification (e.g., a value such as “101”) of character 315 in FIG. 3A and so on. Accordingly, an identification value may be associated with characters or objects in a template (or input) e-book and the identification value or parameter may be included in metadata associated with, or included in, the template (or input) e-book. In an embodiment, an identification parameter of an object, character, element or item in an e-book (either template (or input) or personalized e-book) is unique within the scope of the e-book. Accordingly, objects, characters, elements or items in an e-book may be readily referenced using an identification parameter as shown in FIG. 4 and described herein.

As shown by columns 420, parameters and attributes of an object, character or element in an e-book may be included in metadata 405. For example and as shown, attributes such as location (e.g., in coordinates relative to a page), angle of the face, expression or mood, velocity, movement or speed in an animation may all be included in metadata. Other attributes may be included in a structure associated with an e-book. For example, attributes such as an addition to a face (for example, a mask on half of the face, the structure of the nose, size, complexion, age, color of eyes or hair, height, weight) may all be included in metadata that may be structured as shown by FIG. 4. For example, assuming object 1 in FIG. 4 is associated with the toy truck object 320 in e-book page 310, the color of the toy truck, its orientation or angle (e.g., facing left, facing right or facing up or down), the location of the toy truck in the page, its speed and direction of movement and so on may all be set and/or indicated in columns 420 in metadata 405 as shown. Parameters included in columns 420 may be a velocity value, an angle rotation value and the like.

As shown by columns 430, an object in a template e-book may be replaced by an object provided by a user. For example, to replace an element in a template e-book by an element provided by a user, the identification of the element provided by the user may be inserted into column 430 in metadata of the personalized e-book. For example, to cause (and/or indicate) a replacement of an object in a template e-book by an object provided by a user, the identification of the user object may be inserted into column 430 at the proper row. For example, the toy truck object 320 in a template e-book is replaced by the user object 362 (the toy car) by inserting the identification of the toy car 362 into column 430 at the proper row.

In an embodiment, when user content (e.g., an image) is uploaded to server 110 it is assigned an identification value and stored in association with the assigned identification parameter. For example, each of the elements shown by elements 360 may be assigned a different and/or unique identification value such that they each may be referenced, e.g., in metadata 405. Accordingly, after replacing an object in a template e-book by an object provided by a user, a structure as shown by FIG. 4 may represent a personalized or modified e-book.

In an embodiment, when an element, object or character provided by a user replaces an element, object or character in a template e-book, the attributes and parameters (e.g., as shown by columns 420) are applied to the element, object or character provided by a user. For example, if, based on a parameter in columns 420, the toy track 320 is moving left then, after replacing the toy track 320 with toy car 362, toy car 362 will be moving left in a personalized book. Of course, a user may change any attribute or parameter in columns 420 to further personalize an e-book. For example, after replacing toy track 320 with toy car 362, the user may also change the color or velocity of car 362 by modifying values or data in columns 420.

In an embodiment, an administrator, employee or author sets values or data in columns 420 to generate a template e-book. A user then replaces objects and characters in, or adds elements to, the template e-book (e.g., by inserting element IDs into columns 430) and further changes attributes of added or replaced elements (e.g., by modifying data in columns 420). User's elements may be stored in the system and a system may later automatically generate additional e-books using stored elements.

Metadata 405 may be used to define and/or generate a personalized e-book. For example, with respect to a specific template e-book, metadata 405 is the definition of a specific personalized e-book. With respect to a given or specific template e-book, metadata 405 defines the modifications required in order to generate, from the template e-book, a personalized e-book.

Some of the attributes or parameters in metadata 405 may be user oriented and other may be e-book oriented (e.g., related to a plot or story in an e-book). For example, skin color, height and gender may be regarded as user oriented parameters or attributes while an expression on a face of a character in a specific page may be regarded as e-book oriented. Some of the fields (or columns) in metadata 405 may be modified based on user input while other values or attributes may be fixed or only modified by an administrator or privileged user. For example, a user may be enabled to change a location of a character within an image in a page or change a color of an object in a page (e.g., the color of truck 320). However, if, in a page of an e-book the character is sad or provides sad content (e.g., based on the plot) then it may not be desirable to enable a user to change the mood of the character to “happy” for that page. Accordingly, a personalized e-book may be provided where the user's image replaces an image of a character without otherwise modifying to the story, plot, or other aspects of the template e-book used for generating the personalized e-book. Accordingly, any parameter or value in metadata 405 may be associated with a privilege that indicates whether or not the value or attribute can be changed by a user. For example, e-book oriented attributes or values may be protected by a permission parameter such that a user cannot change them and user oriented attributes or values may be unprotected such that a user can freely change them.

In addition to personal visual elements, the user may need to provide or choose from a selection of data elements, such as skin color, body type and age. These parameters may be used to change the illustrations in the template e-book and fit them to the user. So, if the user for example has a brown skin color, the user may choose characteristics of a character, e.g., such that the body of the illustrated image that will be used in the personalized e-book will be brown. Applying different color skins may be done by selecting a specific character with a specific skin color. For example, for a specific character, an illustrator provides a set of illustrations for the character where each character in the set has a different skin color. In another embodiment, EMU 111 (or another unit) may automatically apply a skin color to a character based on a selection of a user. For example, a user may select a color for a character and EMU 111 may apply the color to the character.

A metadata structure may include additional columns. For example, in one embodiment, the color as shown in columns 420 may be used in order to indicate a skin color. In another embodiment, an additional column may be used in order to record personal or per-user modifications or attributes, e.g., skin color. It will be understood that any personal or per-user modifications or additions to a template e-book may be recorded by any suitable structure such as metadata 405 and that metadata 405 is an exemplary structure.

A definition of a personalized e-book may be used to generate the personalized e-book based on an input or template e-book. For example, to generate a personalized e-book, EMU 111 obtains, generates or accesses a copy of a template e-book (e.g., from template e-books 140) and modifies the copy of the template e-book according to information in metadata 405 to generate the personalized e-book. For example, a template e-book may be stored on storage 130 as shown by 140 and EMU 111 may retrieve the a template e-book from storage 130. In other embodiments, EMU 111 may receive a template e-book. It will be understood that any method may be used, e.g., by EMU 111, to generate, obtain or access a template e-book without departing from the scope of the present invention. Information in metadata 405 may be modified by a user or based on input from the user, accordingly, by modifying a template e-book based on data in an associated metadata 405, EMU 111 can generate a personalized e-book.

EMU 111 may modify a copy of a template e-book according to information, data, parameters or instructions in metadata 405 to generate a personalized e-book, store the personalized e-book (e.g., as shown by personalized e-books 145) and provide the personalized e-book upon request. A plurality of personalized e-books may be saved for each user.

In other embodiments, since metadata 405 and a template e-book fully define a personalized e-book, EMU 111 may only store metadata 405 as a definition of a personalized e-book. When a user requests his or her personalized e-book, EMU 111 obtains a copy of the relevant template e-book, obtains the relevant metadata 405 (e.g., metadata 405 stored in the user's account) and generates the personalized e-book by modifying the copy of the template e-book according to the relevant metadata 405.

A plurality of metadata 405 structures may be used in order to generate a plurality of personalized e-books based on the same template e-book. It will be understood that any e-book, including a personalized e-book may be used as input to a system or method according to embodiments of the invention that generates a personalized e-book. For example, a first personalized e-book may be used as input to a process that generates a second, different e-book. For example, a metadata 405 may be used to generate, from a copy of a first personalized e-book, a second, different, personalized e-book. For example, metadata 405 of the second personalized e-book indicates which characters and objects in the first personalized e-book are to be replaced or changed in order to generate the second personalized e-book.

For example, after generating a first personalized e-book based on metadata 405 as shown, to generate another or different personalized e-book, the same object in a template e-book may be replaced by another or different element, e.g., provided by another or different user. For example, to generate a first personalized e-book, the toy truck 320 is replaced by the toy car shown by 362 by inserting the identification of toy car 362 into column 430 as shown. To generate second, different personalized e-book, the toy truck 320 is replaced by some other object by inserting the identification of that other object into column 430 as shown.

To present a modified or personalized e-book, EMU 111 may retrieve template e-book 140, examine metadata of the personalized or modified e-book and replace elements in the template e-book based on the metadata. For example, when presenting or providing personalized e-book 145 that was generated as described herein, EMU 111 retrieves template e-book 140, and, based on metadata 405 of personalized e-book 145, EMU 111 determines that object 320 is to be replaced with an object provided by a user. As described, in an embodiment, the metadata identifies the object (e.g., using an identification parameter as described) in user data 135 that is to be used in replacing object 320. Accordingly, EMU 111 searches user data 135 for an object associated with the relevant identification value, replaces object 320 with the identified object in user data 135 and thus generates personalized e-book 145.

In some embodiments, EMU 111 may generate a personalized e-book on-the-fly. Generally, generating a personalized e-book may include generating the e-book in real-time, e.g., upon request from a user while generating a personalized e-book in off-line mode may include generating the personalized e-book and storing the personalized e-book for later use. Generating a personalized e-book on the fly or in real-time may be desirable for example in order to save storage space. Real-time or on-the-fly generation of a personalized e-book may enable dynamically modifying a personalized e-book. For example, a user may provide a first user visual content object and have a personalized e-book that includes the provided content immediately generated. If the user does not like the resulting personalized e-book, the user may provide (e.g., upload to server 110) another (second) visual content object and have the system immediately generate a second personalized e-book that includes the second visual content object. Off-line generation of a personalized e-book may be used for example, when a personalized e-book is shared. For example, a personalized e-book may be generated in off-line, stored on server 110 (e.g., as shown by 145) and a plurality of users may download the personalized e-book, thus, the personalized e-book may be shared.

For example, upon request, EMU 111 may retrieve template e-book 140, retrieve metadata for a specific personalized e-book (e.g., from user data 135), replace elements in template e-book 140 to produce a personalized e-book and provide the personalized e-book to a user. In other embodiments, a personalized e-book may be generated and stored, e.g., in off-line mode. For example, a copy of one of template e-books 140 may be modified to produce a personalized e-book 145 and the personalized e-book 145 may be stored in storage 130 as shown.

A personalized e-book may be provided in a number of ways. For example, a PDF or ePUB file containing the personalized e-book may be provided to a computer of a user and the personalized e-book may be presented thereon. In another embodiment, a link (e.g., URL) that points to a personalized e-book on a server is provided, and a web browser is used by the user to see the personalized e-book. In yet another embodiment, an application on a smartphone may be used in order to present a personalized e-book. It will be understood that any combination may be used in generating and providing a personalized e-book. For example, a personalized e-book generated in real-time or on-the-fly may be provided as a PDF file or in online mode (e.g., viewed by a web browser). Likewise, a personalized e-book generated in off-line mode may be provided as a file (e.g., in PDF or ePUB format) or it may be viewed by a web browser (e.g., when stored as HTML code).

A stored personalized e-book may be provided or downloaded to a user computer and presented thereon. Metadata describing elements in a personalized e-book may be used for on-the-fly or for real-time generation of a personalized e-book.

Metadata 405 may be related to a specific page in an e-book or it may be global, e.g., related to a plurality of pages in an e-book. For example, when metadata 405 is global then replacing a character as described herein will replace the character in all pages of the e-book. When metadata 405 is associated with a specific page in an e-book then replacing a character, element or object as described only replaces or modifies the character, element or object in the associated page. Metadata 405 may be related to a specific illustration in a page. For example, a page in an e-book may include, or be divided to, a number of illustrations. For example, a layout of a page in an e-book may resemble the layout of pages in a comics book where a number of illustrations (e.g., in a number of distinct rectangles) are included in a page. In an embodiment, a metadata 405 may be associated with each illustration in a page. For example, a character or object may be modified differently in each illustration in a page and the modification of the character or object in each illustration in the page may be represented in a metadata 405 associated with the illustration. As described, metadata 405 may be used to represent any attributes of elements in a personalized e-book, accordingly, EMU 111 may generate a personalized e-book based on metadata 405 as described. For example, when a user selects to modify a template or input e-book, the selection is recorded in an associated metadata 405 structure and the metadata 405 structure may later be used to generate or regenerate the personalized e-book.

A personalized book may include a global metadata structure that includes data related to all pages in the e-book and additional metadata structures associated with specific pages of the e-book. For example, a global metadata structure 405 may be used to replace a character in all pages of an e-book and an additional metadata structure 405 may be used to override the global settings. For example, a global metadata may be used to replace a character in all pages of an e-book and page specific metadata may be used to set attributes of the character in specific pages. For example, page specific metadata may be used to modify a mood or orientation of the character in a specific page. For example, metadata related to an orientation may include degrees and/or direction of rotation of a face (e.g., with respect to a predefined axis or direction). In another case, page specific metadata may be used to associate audio content with a character in a specific page, change a location of a character or object, change the size of a character or object and so on.

In an embodiment, authors of e-book provide template e-books and metadata for the template e-books is created, e.g., by an administrator or the author. For example, object and character identifications and attributes may be defined for objects and characters in a template e-book by a user. For example, an authoring tool may open a dialog box when an element in a template e-book is clicked and the dialog box may enable a user to select attributes for the element. For example, a user may select the identification value of an object and any of the attributes as shown by columns 420.

In an embodiment, automated tools may be used to identify elements, objects or characters in an e-book and may automatically assign each of the identified objects a unique identification value. For example, automated tool may identify the user's face without the neck and the body, identify the user's face organs such as lips, nose, mouth and ears. Accordingly, the process of identifying elements and associating elements with an identification may be manual, automated or semi-automated. In manual mode, the user may mark the element, the face or the face organs and the identification is based on user marking or input. In semi-automated mode, a system may identify elements, objects or characters or face organs using automated tools and the user may be prompted or asked to confirm or modify an identification or marking done by a system. Any method or system may be used to identify elements in a template e-book and associate the identified elements with an identification value. As described, attributes and parameters associated with elements in a template e-book may be automatically applied to user content. For example, if the expression of character 340 in a template e-book is “happy” (e.g., indicated in metadata 405 of the template e-book) then, when a user replaces the face of character 340 by an image of his face, EMU 111 may examine metadata 405, determine the expression is happy and modify the image of the user to an image of the user smiling. The modified image (showing the user smiling) may be stored with an identification value and the identification value may be entered into column 430 as described. Accordingly, a user may provide an image and a system or method according to embodiments of the invention may automatically modify the image such that the modified image best suits the context in the e-book (e.g., the plot in the story in the e-book).

Generating a personalized e-book may be based on user input, e.g., through an interactive process. For example, an embodiment of a method or flow may include presenting a template e-book to a user. For example, EMU 111 retrieves template e-book 140 from storage 130 and sends template e-book 140 to user computing device 115. User computing device 115 may present template e-book 140. For example, template e-book 140 may be presented by a web browser. Any presentation tool or application may be used on user computing device 115 to present template e-book 140. For example, template e-book 140 may include HTML and/or XML code and, accordingly, may be readily presented by a web browser. Any plug-ins, add-ons may be used, e.g., depending on the format of an e-book presented to a user. A template and/or modified e-book may be generated using any format. For example, if PDF is used then the proper tools and applications may be used to generate and present an e-book. In other embodiments, Java may be used and accordingly, Adobe Flash technology may be used as known in the art in order to generate an e-book, present an e-book and/or enable an interaction with an e-book as described herein. In other embodiments, the free and open e-book electronic publication standard (e-Pub) format may be used to store and present the e-book.

An embodiment of a method for generating a personalized e-book may include integrating user content into a template or other e-book. As described herein, in some embodiments, integration of user content into an e-book may be automated. In an embodiment, a method includes receiving content from a user. For example, a picture is received from a user by EMU 111 on server 110. In one embodiment, EMU 111 may automatically extract a portion from a picture received from a user. For example, face detection techniques known in the art may be used in order to isolate (or extract) a face of a user in (or from) a picture provided by a user.

In another embodiment, an image processing tool may be provided to a user and the user may extract a portion of an original image and provide the extracted portion to a system. For example, a tool may enable a user to draw a circle (or lasso) around a face in an original image and, based on marking of the user, or use an image processing tool that may isolate a face in the original image. The result may be an image that only includes a face, e.g., of a child, without any of the background in the original image. The process may be iterative, e.g., the result is shown to a user that indicates corrections or cleaning required. The process may be repeated until the user is satisfied with the result that may be an image of a face, an image of an object or an image of a person. After an image is approved by the user, the image may be stored and used for generating any number of personalized e-books. As described, an image approved by a user may be uploaded to a system and stored by the system. For example, an image generated and perfected by a user as described herein may be uploaded to server 110 and stored as shown by user data 135. As described, any content provided by a user may be assigned an ID and then used in generating personalized e-books as described. For example, once an image of a user's face is stored in association with an ID the image may be included in a personalized e-book by inserting the ID into metadata 405 and, based on metadata 405 and a template e-book, a personalized e-book the includes the image may be generated.

To help a user generate an image to be included in an e-book, an embodiment may generate an image that includes the image provided by the user. For example, a tool executed on user computing device 115 or EMU 111 may replace a face of a character in an e-book (e.g., replace the head of character 340 in FIG. 3A) with an image of a face provided by a user. Accordingly, the user may see how characters in an e-book will look like when made to include a face provided by a user. As described, any other methods may be used to modify an image or content provided by a user. Once the user is satisfied with an image he or she want included in an e-book, the user may upload the image to the system where it may be stored, e.g., as shown by user data 135.

To help a user generate an image to be included in an e-book, an embodiment may provide the user with an erasing tool that may be used, for example, to remove background from an image. In another embodiment, the cleaning of the background is done using any applicable, automatic, face recognition, method, system or algorithm, e.g., as known in the art. In generating an image to be included in an e-book, input from a user may be received using any method. For example, the user may create, define or mark a lasso around a face in an image as described using his finger on a touch-screen, using a mouse or using arrow keys in a keyboard.

In another embodiment, the cleaning of the background may be done automatically or semi-automatically. For example, an automated embodiment of a method may automatically identify the face of the user in an image (e.g., using face recognition methods known in the art) and further clean or erase any background information from the image such that the image only includes the face of the user. In another embodiment, after automatically identifying the face of the user in an image, a system or method according to embodiments of the invention may draw a circle or other shape around the face and present the circled image to a user for approval. If the user approves the identification, the system may clean any imaging data around the face such that only the face is remained in the image. Any other method of identifying a face in an image may be used. For example, face recognition methods or algorithms may be used to identify a face in an image and the portion of the image that includes the face may be extracted from the image and a new image that only includes the face may be generated using the extracted portion.

In yet another embodiment, a user is enabled to change the brightness and contrast of an image before uploading the image to server 110. In an embodiment, a user may download any content previously uploaded by the user. Accordingly, a user may download an image he or she previously uploaded to server 110, modify the image as described herein to produce new user content and upload the new user content to server 110.

A system may support user accounts as known in the art. For example, a user may first login to his or her account on server 110 and thus cause any content uploaded to server 110 (e.g., user data 135) to be stored under the user account. For example, user data 135 may be private and only shared per indication from an owner of a user account. Similarly, modified e-books may be associated with a user account and only available to users authorized by the owner of the account. Groups may be formed and e-books or user data may be shared by a group.

As described herein, a template e-book may include characters and object and metadata may be used in order to store attributes of characters, objects or elements in the template e-book. For example, the head of character 340 in FIG. 3A may be removed from (or missing in) a template e-book (or the illustrator will be required to provide two sets of illustrations—one with the head and toy truck and one without the head and the toy truck) and metadata associated with the template e-book may indicate the center of the neck of character, angle in which the head is tilting a direction in which the character is looking at and the like. An image of a face provided by a user may be incorporated in a template e-book. For example, based on metadata indicating a direction, tilt, orientation, angle and the like, EMU 111 may replace the head of character 340 with an image of a face provided by a user.

Any modification may be automatically applied to an image provided by a user such that, when replacing a portion of a template e-book, the image provided by a user is best integrated into the e-book. For example, EMU 111 may automatically rotate an image, tilt an image or apply other modifications to an image provided by a user before including it in a modified e-book. For example, if an image provided by a user is a forward facing face and metadata associated with character 340 indicates that character 340 is looking down (e.g., looking at child 315) then EMU 111 may process the image provided by the user, change the orientation or angle so that the face in the image is looking down and only then replace the head of character 340 by the processed image. EMU 111 may optionally then present the resulting page 310 to a user and receive an approval or a rejection from the user. If approved, the image of the user may be stored as user data 135 and used in generating a modified e-book. In an embodiment, a replacement of a portion of an e-book by user content is global. For example, once a user approves an image for replacing an object or character in an e-book, all instances of the object or character (in all pages of the e-book) are automatically replaced.

A replacement in each page may be according to metadata of the character or object in each page. For example, using the same image of a face provided and/or approved by a user as discussed, EMU 111 may make the face look up in one page and look down in another page, e.g., based on page specific metadata associated with the character. Accordingly, an e-book may be personalized by automatically replacing elements in a template e-book with elements provided by a user.

Replacing portions in a template or input e-book may be done using various techniques. For example, instead of first removing the head of character 340 and then fitting a face or head provided by a user to generate a modified e-book, EMU 111 may simply place an image of a face provided by a user on the face or head of character 340. For example, to generate a modified or personalized e-book, EMU 111 may superimpose or overlay an image provided by a user on an image in an input (or template) e-book.

It will be noted that a user may select any character or object in a template or input e-book to be replaced or modified by user content. For example, a user may provide an image of a face and indicate that the provided image will be used to replace, in a modified e-book, the face of character 340 or indicate that the image will be used to replace the face of character 315. Of course, a user may provide a system with a first image to replace the face of character 340 and provide a second, different image, to replace the face of character 340. It will be noted that a face provided by a user may be an image of a face (e.g., an image of the user's face or of the face of a family member) or it may be a cartoon created by a system based on the user's face or a drawing of a face that was sent by the user (or image of a drawing). If a user chooses to replace the face of character 340, then the user can also replace the name of character 340 by his or her name and take the role of character 340 in the e-book. For example, text indicating a name of a character may be included in the template e-book and the text may be modified. For example, a name column in metadata 405 may include a name of a character and replacing the name with the user's name may be recorded in the name column.

An embodiment may save images provided by a user with an associated image identification (image ID) and in association with a user account. Accordingly, a user may keep in the system a number of images (e.g., a number of images of faces) each association with a respective number of image IDs. Accordingly, a system may quickly replace portions of a template e-book with user content. For example, a system may quickly generate a plurality of personalized e-books where in each of the personalized e-books the face of the same character is replaced by a different image provided by the user. For example, a plurality of face IDs may be used to reference a plurality of faces (e.g., in a respective plurality of images provided by a user) so that based on a selection from a user, a different face for a given character may be used to generate different modified e-books.

Identifications may be used for any element in an e-book. Identification (ID) parameters or values may be assigned to any object or element in an e-book. For example, elements or objects may be toys, tools and the like. A user may upload or provide images of any objects and a system (e.g., EMU 111 on server 110 or a module on user computing device 115) may assign IDs to upload images. EMU 111 may present user data 135 to a user. For example, after template e-book 140 is presented to a user, EMU 111 may send images in user data 135 to user computing device 115, user computing device 115 may present the images to the user, and the user may select an image to be used for generating a personalized e-book. For example, user content may be presented to a user as shown by user provided content 360 in FIG. 3A. As described, a template e-book may be presented to the user, e.g., as shown by page 310 (that may be one page of many in an e-book).

In an exemplary embodiment, a user selects an item in a template book to be replaced by personal or user provided content. For example, the user clicks on the face of character 340 in the e-book page shown in FIG. 3A. The ID of the selected item may be saved. For example, the identification of an element (which is the face of character 340) is saved, e.g., in metadata as shown by metadata 405. The user may then select the personal content that will replace the selected item in a template book.

For example, having first selected to replace the face of character 340, the user then selects the face shown by user provided content 360. The ID of item 361 is also saved, e.g., in an instance of metadata 405 as described. Using IDs as described and a template e-book, EMU 111 generates a personalized e-book by replacing user provided content or elements with elements or content in the template e-book. Accordingly, having received, stored and/or recoded user selections and user content, a system and method according to embodiments of the invention can automatically generate a personalized e-book without further input or assistance from the user.

EMU 111 may use an ID of an image provided by a user in order to replace any object, element or item in template e-book 140, not only faces or whole body of people. For example, instead of replacing a whole character or only a face as described, an image of a personal item (e.g., a child's potty) may be used to replace an element in a template e-book thus producing a personalized e-book. IDs may be assigned to any item or element in a template e-book and any image or other content provided by a user may be used to replace elements in a template e-book in order to generate a personalized e-book. By associating an ID with any chosen element in a template e-book, any chosen element may later be replaced by user content as described. For example, a first ID may be associated with a face of a character, a second ID may be associated with the entire character and a third ID may be associated with the shoes or feet of the character. Thereafter, each of the face of the character, entire character and/or shoes or feet of the character may be separately replaced with an image or content provided by a user. Two or more items or elements may be replaced to produce a personalized e-book. For example, the face and shoes of a character may be replaced by a face and the shoes of a user.

An image (or other content) provided by a user may be automatically modified to generate modified user content and the modified user content may be included in a personalized e-book. For example, based on a theme, genre or other aspects, EMU 111 modifies an image of a face to generate a modified face and includes the modified face in a personalized e-book. For example, a user can provide an image of his face and EMU 111 may modify the image to generate a cartoon image of the user. The cartoon image may then be used to replace a face of a character in a template e-book to generate a personalized e-book. For example, a cartoon image of a user may be save with an identification and may be used to replace a character or a face as described herein when generating a personalized e-book. Accordingly, a personalized e-book may be in the form of a comic book. A plurality of cartoons or cartoon images may be generated automatically by a system. For example, EMU 111 may use a set of predefined rules or styles in order to generate a plurality of cartoons or cartoon images from an image provided by the user. The plurality of cartoon images may be stored (and assigned an identification) and/or presented to a user. The user may select any one of the cartoons to replace a face or character in an input e-book when defining a personalized e-book. By associating each cartoon with an identification value, the cartoons may be included in a personalized e-book as described with respect to other user content included in a personalized e-book. For example, an identification of a cartoon image is inserted into column 430 to indicate a replacement of a face with the cartoon in a personalized e-book

In an embodiment, a modifier 165 may be a filter that converts an input image to a cartoon style image. The set of modifiers or available styles may be presented to a user (e.g., sent from server 110 to computing device 115 and presented thereon). A user may select a style, e.g., by selecting the modifier and EMU 111 may modify user data 135 based on the selected modifier. Accordingly, a personalized e-book may be styled based on user preferences. One modifier may be chosen for an entire personalized e-book or different modifiers may be chosen for different pages in a personalized e-book. For example, a column in metadata 405 may indicate which modifier is to be applied to a character or object in an e-book based on the type of the illustrations in the e-book. For example, if the template or input e-book has abstract style a more abstract cartoon of the user will be used or if the template e-book includes watercolor styled illustrations, a water color cartoon style of the user is generated and used to generate a personalized e-book. Accordingly, styling choices received from a user may be stored in metadata and the personalized e-book may be generated as described.

In an embodiment, a user may indicate a style or modifier each time the user wants to read or see the personalized e-book. For example, EMU 111 may receive an indication of a style or modifier and a selection of one or more characters, modify a template e-book based on the indication to generate a personalized e-book and deliver the personalized e-book to the user. For example, by replacing an ID of a modifier in metadata 405 as described and then generate a personalized e-book based on the resulting metadata 405, EMU may generate a personalized e-book on-the-fly, based on user preferences or choices.

Choosing a modifier, e.g., a cartoon style, may be automatic. For example, EMU 111 may be configured to select a cartoon style based on a style or other aspect of a template e-book. For example, EMU selects a cartoon style to be applied to characters in a template e-book based on the type of illustrations in the template e-book. In another embodiment, EMU 111 applies a cartoon style or modifier based on attributes of element in a template e-book. For example, EMU 111 generates a cartoon image from an image of a user's face based on organs in the face. In other embodiments, modifying an image may include replacing organs (e.g., nose or eyes). For example, a long nose or funny eyes may replace a nose or eyes of a user in an image. A system and method according to embodiments of the invention may manipulate, modify or change specific organs in an image of a face or body. For example, EMU 111 identifies the organs in the face and, if the e-book requires (e.g., as indicated in associated metadata) that the hero will have a longer nose in some pictures, then EMU 111 extends the nose of the hero in this specific e-book. For example, the user may select to replace the face of the hero with his or her face. In this example, EMU 111 will modify an image of the user to generate an image of the user in which the user has a long (e.g., Pinocchio style) nose. In the above example, the result will be a hero having the face of the user and further having a long nose.

As described, a system may store a set of images of the user where each stored image expresses (or shows an expression of) a different mood. For example, a set of images of a face of a user may include a first image showing the user's face when smiling, a second image showing the user's face when crying or sad and so on. The set of images may be obtained or generated. For example, images showing different moods may be provided by the user. In an embodiment, images showing different moods may be generated based on an image of a face of the user. For example, EMU 111 may modify an image of the user to produce images showing different emotions or moods. For example, by changing angles of lips an image may be modified to show the user smiling or sad. Other modifications applied to an image (e.g., by EMU 111) in order to generate images that express various emotions or moods may be narrowing the eyes, lifting the eye brows or adding wrinkles around eyes. Yet other modifications may include opening the mouth, inflating cheeks widening the nose and so on. Any method (e.g., as known in the art) may be used to automatically modify an image of a user in order to generate a set of images that express a set of emotions or moods. A set of images expressing various moods or emotions may be generated, by EMU 111, for a user and stored for the user. Each image in a set of images may be marked or tagged so that the mood expressed in the image can be determined by EMU 111. Accordingly, if, according to a story or plot in an e-book, a character is happy, EMU 111 may replace the character's face with an image of the user where the image shows the user smiling. For example, to generate a personalized e-book when the user has selected to replace a specific character with himself, EMU 111 examines metadata 405 for each page or illustration, determines the mood of the character in the page or illustration and selects, from a set of images described herein, an image of the user that shows the user expressing the determined mood.

A set of images for a user that show the user from different point of views or in different angles with respect to a point of view may be may be obtained or generated and stored. For example, using a front view image of a face of a user EMU 111 may automatically generate a set of images that show the user from the left, right or bottom, e.g., as if each image was taken from a different side or point of view. In an embodiment, a three dimensional (3D) image may be generated from a two dimensional (2D) image of the user and different images showing the user from different sides may be generated by slicing the 3D image. Other automated methods may be used in order to generate images of a user that show the user from different angles or that show different sides of a user's face or body.

Images showing a user or a user's face from different angles may be stored and tagged and used as needed. For example, if in order to generate a personalized e-book, EMU 111 needs to replace a face of a character in a template e-book by a face of a user and the character in the template e-book is looking left, EMU 111 may select an image of the user in which the user is looking left. An orientation, e.g., the direction the user in an image is facing or looking may be defined using degrees, e.g., a direction may be defined as 30 degrees to the left with respect to a predefined axis. For example, metadata 405 may indicate a rotation by degrees and, when generating a personalized e-book, EMU 111 may rotate a face of a user by the indicated degrees. For example, EMU 111 may generate a view of the user's face when rotated using a 3D image of the user's face as described herein. For example, an image of the right side of the user's face may be selected so that the user seems to be looking left. Accordingly, by generating and storing a set of images of the user showing the user from different perspectives or angles, a system may then select from the set images such that images of the user can properly be inserted into a personalized e-book. A set of images of a user may show the user from different sides and, in addition, show the user according to a mood. For example, an image of the user looking left and smiling or looking right and crying may be generated as described herein. For example, first, a set of images showing different moods may be generated and, for each of the generated images, a set of images from different angles may be generated.

Identifying the organs can be done automatically using face recognition techniques known in the art, or manually by asking the user to mark them with for example a lasso or dots, or semi automatically by identifying them and asking the user to confirm and correct.

An image provided by a user may replace an element in an e-book. For example, an image of a face of the user may replace the face of a character in an e-book as described. The same image of the user may be used to replace different characters in different e-books. Accordingly, a plurality of personalized e-books may be generated using the same set of images provided by a user. For example, by entering a reference to an image provided by a user into a set of metadata 405 related to a respective set of template e-books, a set of personalized e-books may be generated such that, for example, the same faces appear in all of the personalized e-books. A user may provide a set of images and EMU 111 may randomly or otherwise insert the images into personalized e-books. For example, a user may provide a set of images of the user's face and EMU 111 may randomly replace faces in a template e-book to generate a personalized e-book. EMU 111 may randomize insertion of images between pages in the same personalized e-book.

A set of images provided by a user may be analyzed to determine expressions therein. For example, any technique known in the art may be used to determine an expression of a face (e.g., happiness, anger, surprise etc.). For example, EMU 111 may determine expressions in user content 135 and indicate an identified expression in an image. In another embodiment, a user may provide a set of images with different expressions. EMU 111 may store the set of images and further associate each image with an indication of the expression. For example, “1” may indicate happy, “2” may indicate sad, “3” may indicate surprised and so on. The same values may be used, for example, in the column titled “expression/mood” as shown by columns 430 in FIG. 4. Accordingly, images that express specific emotions may be included in a personalized e-book based on an indication of a mood. Creating an expression can be done by either replacing a an organ in a face (e.g., mouth, nose, eyes etc.) or by manipulating organs. For example, if a character in a specific page of the book should be happy (e.g., as indicated by metadata 405 of the page), then EMU 111 will create a happy face from a picture of the user by making the mouth of the user wider and by making the edges of the mouth go up.

When replacing content in a template e-book, EMU 111 may insert images based on an expression in an image. For example, based on the mood or expression as shown in metadata 405, EMU 111 may search for an image with a matching expression and may choose that matching image as the image that will be used in generating the page of the personalized e-book. For example, if the mood or expression as indicated in metadata 405 is “anger” then EMU 111 may insert a reference to an image that was found to be one with an expression of anger as described.

In an embodiment, EMU 111 may modify an image of a user such that the modified image is one that expresses an emotion, e.g., anger, happiness etc. EMU 111 may store a plurality of modified images that express a plurality of emotions and use such images to generate a personalized e-book by including images with a proper expression into the personalized e-book. For example, if for a first page, metadata 405 indicates that the mood of a character is “happy” then EMU selects an image of the user in which the user smiles (for example, smile detection may be used to identify such image). If, for a second page, metadata 405 indicates the character is “sad” then EMU 111 selects an image of the user in which he expresses sadness.

EMU 111 may use text analysis to determine the context of a text in an e-book (e.g., the story or plot) and select images with expressions as described herein based on the text or context of in an e-book.

Modifying an image of a user (or other content provided by a user) may include changing an angle or orientation. For example, provided with a front view image of a face of a user, EMU may generate a set of images that show the user as facing left, right, down, up and so on, as well as different stages of facing semi-left right, etc. Any known in the art techniques may be used to modify an image to achieve orientation or angle effects. EMU 111 may then select images for generating a personalized e-book based on orientation or angle. For example, based on the orientation column in columns 430, EMU 111 can determine the required orientation of a character in a specific page. Accordingly, EMU 111 may select an image of the user with the proper orientation for each page in a personalized e-book.

As described herein, to generate a personalized e-book, any item, element, object or character in a template e-book may be replaced by content provided by a user. In addition, a scene or location may be provided by a user. For example, a user may provide a scene or location, e.g., an image of his bedroom or an image of her schoolyard and the scene or location may be used to generate a personalized e-book. For example, EMU 111 uses an image of a location provided by a user as the background in pages of a generated personalized e-book.

A location provided by a user may be relevant to other users. For example, a schoolyard may be a location relevant to the user and to friends of the user. By entering a reference to an image of the schoolyard into metadata related to a plurality of personalized e-books, EMU can cause a location or scene to be shared by users. For example, the same image of a schoolyard may be used as the background in a plurality of personalized e-books generated for a plurality of friends in school. Reference to a location can be an indication (e.g. name) of a school, city, country and/or zip code or a reference may be based on information in a social network as described herein.

Various methods may be used in order to associate a plurality of users and associate the personalized books generated for the associated users. For example, users' accounts on server 110 may include a reference to a social network. For example, a user account on server 110 includes a reference to a facebook account (e.g., user name) and required credentials (e.g., password). For example, EMU 111 may use facebook or Goggle+ information in a user account on server 110 in order to identify friends of the user and suggest to identified friends to share a personalized e-book. For example, an image of a schoolyard provided by a student as a location for a personalized e-book may be suggested to friends of the student as a background for their personalized e-books.

By linking friends or other users, e.g., friends or members of a social network, a system may enable a user to include images of other users in a personalized e-book. For example, in addition to presenting user provided content as shown by user content 360, EMU 111 may present images of friends of the user and the user may select images of friends to be included in a personalized e-book. For example, a user may select an image of a face of a friend that will replace the face of character 340. For example, using account information and credentials provided by a user, EMU 111 may log into the user's facebook account, retrieve image of friends of the user and present the images to the user, thus enabling the user to select images of friends, or content provided by friends, to replace elements in a personalized e-book.

Accordingly, a user may provide a plurality of images of faces of a respective plurality of people and a personalized e-book may be generated by replacing characters (or images) in a template e-book with images of faces of the plurality of people. For example, a personalized e-book may be generated by replacing a number of characters in a template e-book by images of friends of the user.

In an embodiment, a user may indicate a name of a friend and EMU 111 may search accounts in server 110, locate an account of a user with the indicated name and include an image of the friend in a personalized e-book. In an embodiment, EMU 111 may locate an account of a friend, present images of the friend (e.g., stored in user data 135 or obtained from a social network) and receive, from the user, a selection of an image to be included in a personalized e-book. In another embodiments, a user may specify a user name in a social network and EMU 111 may search the social network (e.g., using provided credentials as described) and retrieve images of the specified user. A user may create a social e-book by uploading a picture of a friend and select to replace an image in a template or input e-book with the image of a friend. For example, in order to create a personalized e-book with images of more than one person, a system may either save headless versions of all the characters in the input e-book and, if the user replace faces of all characters then generate a personalized e-book accordingly. If the user replace only part of the characters (or faces of characters), the system may insert illustrated original characters where no user selection was received. Accordingly, elements in an input e-book may be used unless replaced by the user.

A personalized e-book may be shared. For example, a user may indicate other users who can download or see a personalized e-book and EMU 111 may enable indicated users to see the personalized e-book. After a user indicates that a second user may see a personalized e-book, when the second user logs into server 110, EMU 111 may notify the second user that an e-book was shared with him or her. In another embodiment, if a first user includes in a personalized e-book content provided by a second user then EMU 111 may inform the second user of such inclusion and/or, based on permission from the first user, share the relevant personalized e-book with the second user. A few users can create a social book in which at least one of the characters in the book is replaced by one of the users. A number of different characters in an e-book can be replaced by a respective number of users. Once characters in an e-book are replaced by (or personalized according to) users, additional e-books may be generated based on the replacement or personalization. For example, if a character that appears in a first e-book also appears in a second (e.g., a sequel or follow-up e-book) then a replacement or personalization of the character may be done automatically be a system. For example, a new chapter of an e-book, personalized for a group of friends in a social network, is released every week and provided to the group of friends. A group of users may modify or personalize an e-book as described herein. For example, by enabling a group of users to access and modify metadata 405 of a personalized e-book, a system enables a group of users to collaboratively personalize an e-book.

When generating a social personalized e-book, a system or method according to embodiments of the invention may user layers described herein. For example, as described, images in a template or input e-book may include layers where information in images is divided into layers (e.g., bodies of characters are in a first layer and faces are in a second layer). As known in the art, layers may be manipulated or handled separately. For example, to generate an image in a personalized social e-book, a layer that only includes bodies of characters may be obtained and images of a number of users may be used to add faces to the bodies.

However, if a user only selects to replace faces of some of the characters in a template social e-book then a system may need to handle and fill-up the heads of the other characters. For example, if a template e-book includes three characters and a user selects to replace the faces of two of the characters with faces of her friends then a system needs to assure that the third character will have a face in the personalized e-book. In an embodiment, a system starts with a layer that only has headless bodies of characters. Next, the system or method according to embodiments of the invention fits faces selected by the user onto the headless bodies according to the user's selection. Next, if headless characters remain, the system or method according to embodiments of the invention may obtain faces from a layer that only includes faces and fits those faces onto the remaining characters. Accordingly, the resulting personalized social e-book may include some characters that are personalized (e.g., have faces of friends of the user) and some characters that are not characterized but are generated by incorporating bodies from a first layer and faces from a second layer. For example and as described, an illustrator provides the layers, e.g., the illustrator of a template e-book provides a layer with headless bodies and a layer with faces only.

A user may not only replace characters, faces or objects in a template e-book to generate a personalized e-book but may additionally or alternatively add objects of characters to a template e-book. For example, additional rows may be added to metadata 405 in order to add objects or characters to a template e-book when creating a personalized e-book. For example, EMU 111 may present a set of headless characters (e.g., stored on storage 130) and the user may select a body of a character to be added to a template e-book. Next the user may select a face for the new character, e.g., the user selects his own image as described. Next, the user may click a location in a page where the new character will be added or choose to add it automatically to all pages of the book. User selections may all recorded in metadata as described. Accordingly, a child may generate a personalized e-book in which he or she appear as an addition to the original or template e-book. The set of character bodies may be provided, for example, by the original artist, e.g., the artist that created the template e-book. A character added to an e-book may be active. For example, movement, animation, location, audio or other attributes may be associated with a new or added character. Text may be added by a user to a template e-book to generate a personalized e-book. For example, the user may click on a page, enter text, select effects (e.g., a text balloon, a thought balloon) and the added text and effects may be recorded or included in a personalized e-book.

Any template e-books may be used. For example, template e-books may be designed to help students in learning various subjects. For example, a template e-book may be designed for teaching mathematics, history, languages, the alphabet (e.g. “ABC”), science, geography and the like. For example, a template e-book may include images or text related to historian moments or different geographic locations thus, when a personalized e-book is generated, a child can see himself in different geographic locations (to teach geography), history moments (to teach history), near objects with names relevant according to the ABC (to teach languages) or inside numerical objects (to teach math), etc. For example, a child may appear as a roman solider when personalizing a template e-book related to history.

Although e-books are mainly referred to herein, other content types may be personalized as described. For example, a template e-book as referred to herein may be, or may include, a music clip or video. Faces of characters in a video may be replaced as described herein. Characters in a video clip or multimedia content may be replaced and objects may be added or replaced. Where applicable, methods and a system described herein for personalizing an e-book may be used for personalizing multimedia content. For example, additional columns in metadata 405 may indicate a rhythm, a sequence of steps and the like. Accordingly, a multimedia content object may be modified to generate a personalized content object. Background, audio effects and the like may all be added or modified in a template multimedia content object (as descried herein with respect to an e-book) to generate a personalized multimedia content object. For example, a video clip with a layer that has characters can be used so the user may select to star in the video clip as one of the characters as described herein. The selected faces may be included in the video clip to generate a modified or personalized video clip. It will be understood that a system and methods described herein with respect to e-books may be applicable to multimedia content. For example, locations of characters, expressions and the like may be modified in a template video clip when generating a personalized visual characteristic video clip. In other embodiments, new characters or objects may be added to a video clip or multimedia content using a system and methods as described herein. Marking a location of a neck and placing a head or face based on the marking may be used in conjunction with multimedia content such as animation or video. Layers described herein may be used in personalizing multimedia content. For example, a first layer may include headless characters and a second layer (that may be superimposed on the first layer) may include user specific content, e.g., images of faces and the like.

Other content that may be produced by a system may be a television (TV) program. For example, a personal layer may be defined over a TV program. The personal layer may include photos or video of headless characters. EMU 111 may mark the place of the center of the neck of each headless character and a user may then select to attach his face to one of the headless characters based on the center of the neck. Similarly, a movie may be generated. Other content generated as described may be a personal advertising e-book or video clip.

Animation effects may be added to a personalized e-book. For example, a jump, roll or other movements may be applied to a character or object (possibly properly indicated in associated metadata).

Any content generated by a system and method as described herein may be printed. For example, EMU 111 may generate a personalized e-book as described and may further print the personalized e-book or provide the personalized e-book to the user as described and the user may print the personalized e-book. Personalized or other e-books generated as described herein may be presented by any suitable system. For example, a personalized e-book or advertisement may be presented on a billboard or presented by a TV set as a program or clip.

A system may enable artists or other content creators to sell content. For example, artists may upload graphic content (e.g., characters, faces and the like) to server 110. When a user searches for content to be included in his or her personalized e-book, the content uploaded by the artists may be presented (e.g., in the same way user content is presented) and a user can select content provided by an artist to be included in the user's personalized e-book. The user may be requested to pay for content provided by artists and server 110 may transfer some of the payment to the contributing artist. For example, artists may contribute scenes or backgrounds, illustrations, images, audio clips, formatted text and the like. Content provided by contributing artists may be stored on storage 130 and offered to users. For example, EMU 111 may present content provided by artists to users who can select to include such content in their personalized e-books.

Elements in a template e-book may be associated with content contributed by artists. For example, when a user clicks on text in a template e-book, a list of relevant content items may be presented enabling the user to select an item to be included in a personalized e-book. It will be understood that metadata associated with a template or personalized e-book as described may enable associating elements in an e-book with external content such as content contributed by external artists.

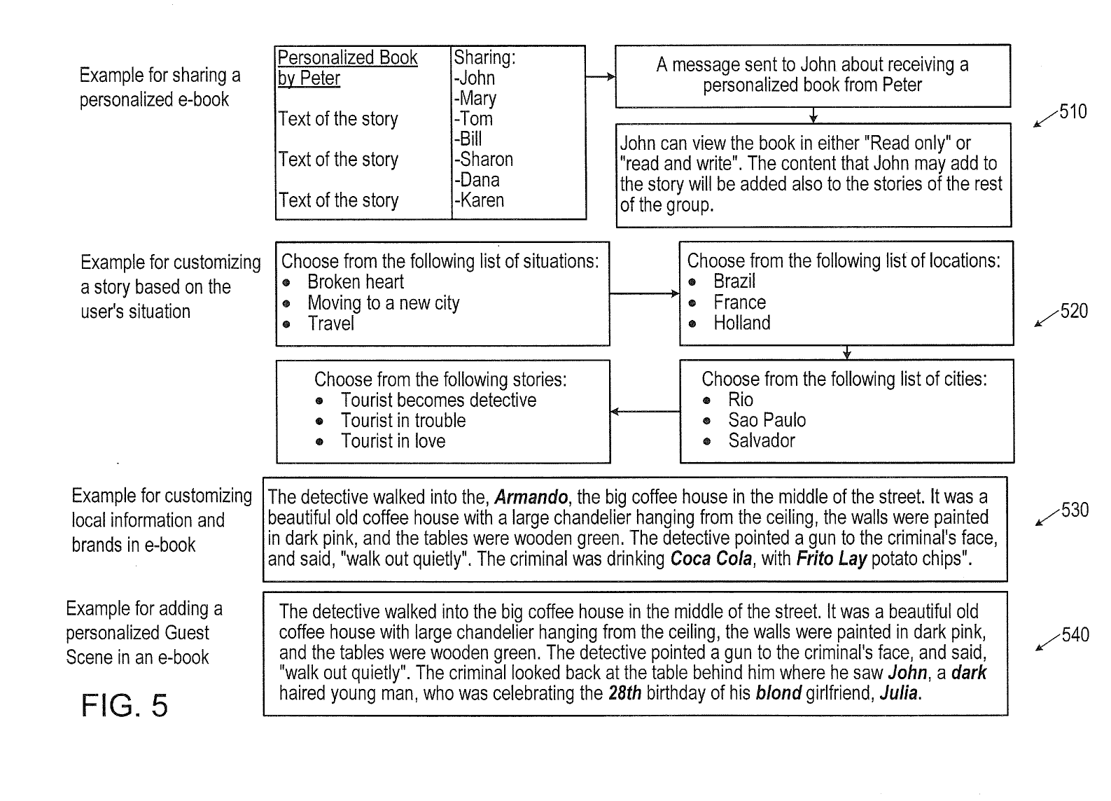

Reference is now made to FIG. 5 that shows exemplary screenshots according to embodiment of the invention. As shown by blocks 510, a user may share a personalized e-book. For example and as shown, EMU 111 (or a module installed on user computing device 115) may present to a user (Peter in this example) a list of other users with which the user can share the personalized e-book. For example, the list of other users shown may be retrieved from a social network as described or from user accounts on server 110. As shown, after Peter selected to share the personalized e-book with John, John can now see the personalized e-book or even edit the personalized e-book. For example, permissions may be set by Peter and recorded in user data 135 such that some users may only see the personalized e-book while other users may also edit the personalized e-book.

As shown by blocks 520, a situation may be chosen (and recorded in associated metadata), a location may be chosen, a city may be chosen and the story or plot in an e-book itself may be chosen. Based on user choices, EMU 111 may select a template e-book, select background, location and/or other attributes, generate a personalized e-book and present the personalized e-book to the user, e.g., as a starting point. The user may then further modify or personalize the personalized e-book as described herein.

As shown by blocks 530, text segments may be modified. For example, specific text strings in a template e-book may be marked (e.g., in metadata) and/or be clickable so that when clicked, a list of possible texts for replacement is presented. Accordingly, to personalize an e-book, a user can choose to replace text in the template e-book. In an embodiment, free text may be entered and may replace existing text. As shown by blocks 540, names, colors and the like in a template e-book may be replaced to generate a personalized e-book.

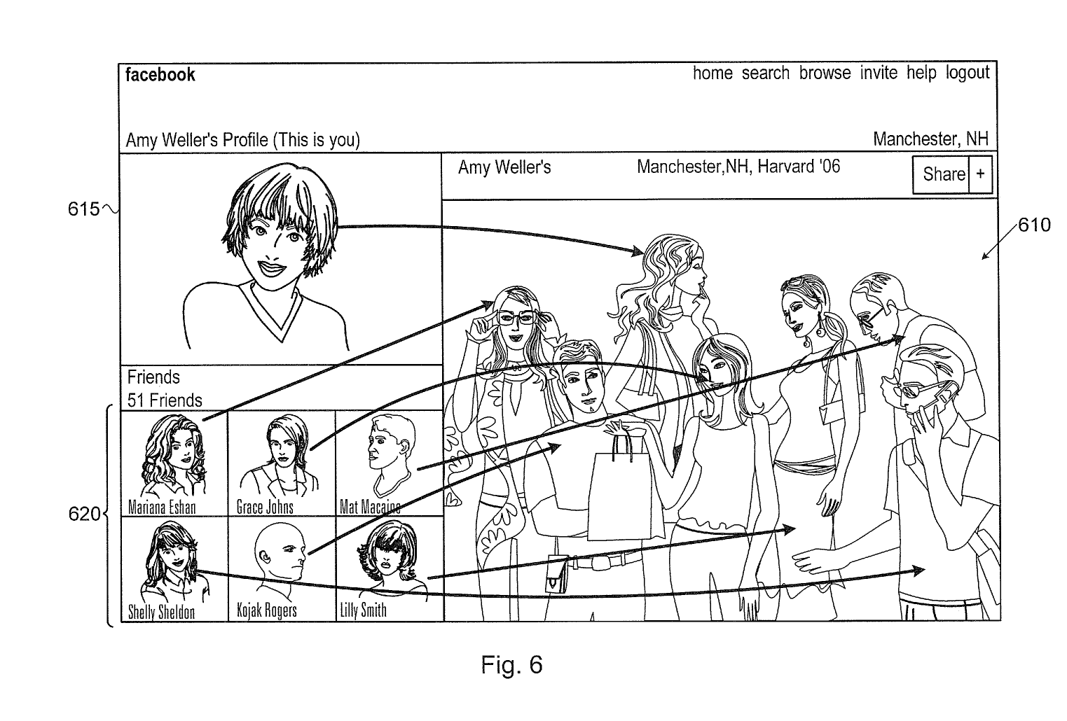

Reference is now made to FIG. 6 that shows exemplary screenshots according to embodiment of the invention. As shown by block 610, a page of a template e-book may be presented to a user. As shown by block 615, a user may be presented with her own image, may click on her image and then click on a character in the template e-book (“Snow White” in this example) thus indicating the character is to be replaced with the user in the personalized e-book. As shown by block 620, a user may be presented with images of other users (e.g., facebook friends) and the user may further click on an image of a friend and then click on a character in the template e-book thus indicating the character is to be replaced with the friend, e.g., as described herein.

A personalized social c-book may be created by one user who assigns role to other users (e.g., friends in a social network) who then get notified that they are participating in the e-book and can then choose if they would like to receive a copy of the e-book. Alternatively, the user who initiates the creation of the e-book can send invitations to friends who can then each choose a character in the personalized e-book based on availability. Each user can further personalize his or her character. Also, after a social book is created, the users who participate in it can subscribe to sequels or follow-ups of the book or different editions. A system may automatically create personalized e-books for a plurality of users based on their preferences. If a social e-book is created and one of the users decides to personalize parts of the books that are not specific to his or her character, the other users may choose to accept this personalization or reject them. For example, metadata 405 structures may be accessible to a plurality of users so that a group of users may all change a personalized e-book. For example, each user may change attributes of one character and the attributes are recorded in a common metadata structure 405 that is common to all users and is further used to generate the e-book.

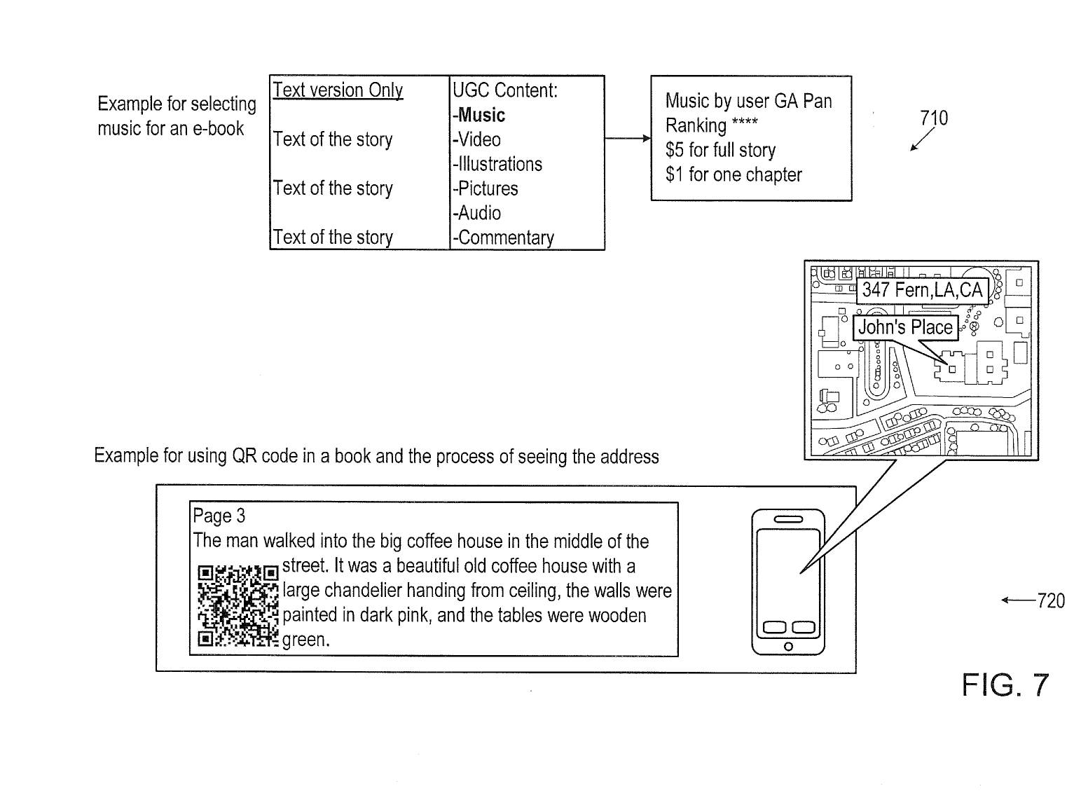

Reference is now made to FIG. 7 that shows exemplary screenshots according to embodiment of the invention. As shown by block 710, content may be offered to a user. For example and as shown, content categories such as music, video, pictures and the like may be presented and the user may select content to be included in his or her personalized e-book. As shown by block 720, a template e-book may include a Quick Response (QR) code that may be used in order to provide additional information related to a story or plot in an e-book. For example and as shown, the QR code may provide location information related to the text.

Reference is made to FIG. 8, showing a high level block diagram of an exemplary computing device according to embodiments of the present invention. Computing device 800 may include a controller 805 that may be, for example, a central processing unit processor (CPU), a chip or any suitable computing or computational device, an operating system 815, a memory 820, a storage 830, an input devices 835 and an output devices 840.

Operating system 815 may be or may include any code segment designed and/or configured to perform tasks involving coordination, scheduling, arbitration, supervising, controlling or otherwise managing operation of computing device 800, for example, scheduling execution of programs. Operating system 815 may be a commercial operating system. Memory 820 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 820 may be or may include a plurality of, possibly different memory units.

Executable code 825 may be any executable code, e.g., an application, a program, a process, task or script. Executable code 825 may be executed by controller 805 possibly under control of operating system 815. For example, executable code 825 may be an application designed to personalize an e-book or carry out other operations performed by EMU 111 as described herein. Accordingly, in an embodiment, EMU 111 may be or may include controller 805 and executable code 825. Where applicable, executable code 825 may carry out operations described herein in real-time. Computing device 800 and executable code 825 may be configured to update, process and/or act upon information at the same rate the information, or a relevant event, are received. In some embodiments, more than one computing device 800 may be used. For example, a plurality of computing devices that include components similar to those included in computing device 800 may be connected to a network and used as a system. For example, generating a personalized e-book may be performed in realtime by executable code 825 when executed on one or more computing devices such computing device 800.

Storage 830 may be or may include, for example, a hard disk drive, a universal serial bus (USB) device or other suitable removable and/or fixed storage unit. Content may be stored in storage 830 and may be loaded from storage 830 into memory 820 where it may be processed by controller 805. In some embodiments, some of the components shown in FIG. 8 may be omitted. For example, memory 820 may be a non-volatile memory having the storage capacity of storage 830. Accordingly, although shown as a separate component, storage 830 may be embedded or included in memory 820.

Input devices 835 may be or may include a mouse, a keyboard, a touch screen or pad or any suitable input device. It will be recognized that any suitable number of input devices may be operatively connected to computing device 800 as shown by block 835. Output devices 840 may include one or more displays, speakers and/or any other suitable output devices. It will be recognized that any suitable number of output devices may be operatively connected to computing device 800 as shown by block 840. Any applicable input/output (I/O) devices may be connected to computing device 800 as shown by blocks 835 and 840. For example, a wired or wireless network interface card (NIC), a modem, printer, a universal serial bus (USB) device or external hard drive may be included in input devices 835 and/or output devices 840.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 820, computer-executable instructions such as executable code 825 and a controller such as controller 805.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a workstation, a server computer or any other suitable computing device. Unless explicitly stated, the method embodiments described herein are not constrained to a particular order or sequence. Additionally, some of the described method embodiments or elements thereof can occur or be performed at the same point in time.

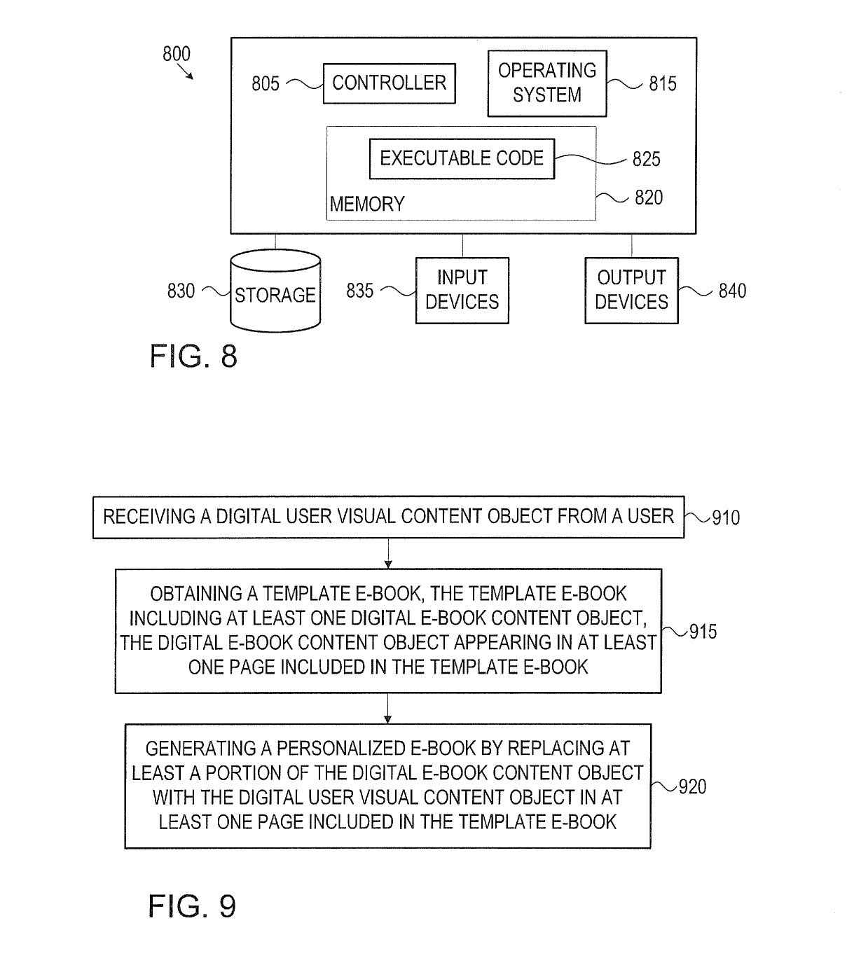

Reference is made to FIG. 9 which shows a high level block diagram of a flow according to embodiments of the invention.

As shown by block 910, an embodiment of a method may include receiving a digital user visual content object from a user. For example, a user may upload digital user visual content objects to server 110 and the uploaded digital user visual content objects may be stored as shown by user data 135. In other embodiments, emu 111 may receive digital user visual content objects directly from a user. EMU 111 may receive or obtain digital user visual content object from storage 130.

as shown by block 915, an embodiment of a method may include obtaining a template e-book, the template e-book including at least one digital e-book content object, the digital e-book content object appearing in at least one page included in the template e-book. For example, EMU 111 may retrieve template e-book 140 from storage 130. In some embodiments, EMU 111 may copy template e-book 140 and use the copy so that the original template e-book is preserved and a personalized e-book is generated using the copy. Accordingly, a single template e-book can be used to generate a large number of different personalized e-books. For example, an author or illustrator may provide a template e-book and EMU 111 may use the template e-book to generate any number of personalized e-books by copying or duplicating, for each personalized e-book, the provided template e-book and using the copy to generate a personalized e-book.

A template e-book may include at least one digital e-book content object. A digital e-book content object may be any applicable digital object. For example, a digital e-book content object may be an image, an illustration or an animation. Exemplary digital e-book content objects are shown by characters 315 and 340 and objects 320, 325 and 330 in FIG. 3A. It will be understood that digital e-book content objects may be any digital objects included in an e-book as described herein.

A digital e-book content object may appear in only one page or slide of an e-book or it may appear in a plurality of pages or slides of the e-book. For example, the same character may appear in more than one page of a template or personalized e-book. For example, a hero or narrator may appear in each and every page of an e-book, in the first page or in some of the pages.

As shown by block 920, an embodiment of a method may include generating a personalized e-book by replacing at least a portion (all or a portion) of the digital e-book content object with the digital user visual content object in all or in at least one page included in the template e-book. For example, a portion of a digital e-book content object may be the face of a character in a template e-book, and generating a personalized e-book by replacing a portion of the digital e-book content object with the digital user visual content object may include replacing the face of the character in a template e-book by an image of a face of a user. At least a portion of a digital e-book content object may be a part of an object or character, e.g., a face or body, or it may be an entire object. For example, replacing at least a portion of a digital e-book content object with a digital user visual content object may include replacing an image of a character in a template e-book by an image of a user.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method of generating a personalized electronic book (e-book), the method comprising:
receiving a digital user visual content object from a user;
obtaining a template e-book, the template e-book including at least one digital e-book content object, the digital e-book content object appearing in a plurality of pages included in the template e-book; and
generating a personalized e-book by replacing at least a portion of the digital e-book content object with the digital user visual content object in at least some of the plurality of pages.

2. The method of claim 1, wherein the user visual content object is an image of a face, the method comprising:
receiving from the user a marking of the face in the image and removing background information from the image to generate a modified image that only includes the face; and
storing, on a server, the modified image of the face in association with an account of the user.

3. The method of claim 2, wherein the template e-book includes an indication of a location of a face of a character in the template e-book and wherein replacing the digital e-book content object with the digital user visual content object includes replacing a face of the character with the face in the image according to the location.

4. The method of claim 2, wherein the template e-book includes an indication of an orientation of a face of a character in a story and wherein replacing the digital e-book content object with the digital user visual content object includes replacing a face of the character with the face in the image according to the orientation.

5. The method of claim 3, wherein the character in the template e-book is a headless character, the headless character includes a mark of the center of the neck of the headless character, and wherein the method further comprising attaching the face of the user to the headless character based on the mark.

6. The method of claim 2, comprising:
obtaining a plurality of images of faces of a respective plurality of people; and
generating the personalized e-book by replacing at least a portion of at least two different digital e-book content objects in the template e-book with at least two respective different images of faces.

7. The method of claim 2, wherein the template e-book is associated with metadata, the metadata indicating a specific expression of a character, the method further comprising modifying the face in the image according to the expression to generate a modified face and replacing the face of the character with the modified face wherein modifying the face in the image includes one of: replacing face organs with other organs and modifying face organs.

8. The method of claim 2, comprising:
receiving from the user a plurality of images of faces expressing a respective plurality of expressions;
determining an expression of a character included in the template e-book; and
selecting to replace the face of the character with one of the plurality of faces based on the expression.

9. The method of claim 3, comprising:
modifying the face in the image to produce a plurality of images that show the face from a respective plurality of angles;
storing the plurality of images; and
selecting, from the plurality of images, an image for inclusion in the personalized e-book based on metadata associated with a character in each specific illustration of the book.
replacing a face of the character with the face in the image according to the location and according to an angle indicated in the metadata.

10. The method of claim 2, comprising generating a cartoon image based on an image of a face of the user based on a selection of a style.

11. The method of claim 1, wherein the user visual content object is an image of an object and wherein replacing at least a portion of the digital e-book content object with the digital user visual content object includes replacing an object in the template e-book with the user visual content object.

12. The method of claim 1, wherein the user visual content object is an image of a location.

13. The method of claim 1, comprising determining a location related to a second user and generating a personalized e-book for the second user by including an image of the location in the personalized e-book.

14. The method of claim 1, comprising adding a character to a story in the template e-book by adding the digital user visual content object to the template e-book.

15. The method of claim 1, wherein the template e-book includes multimedia content and wherein the digital user visual content object is used to replace a portion of the multimedia content.

16. A system for generating a personalized electronic book (e-book), the system comprising:
a server;
an electronic book (e-book) modification unit installed on the server, the e-book modification unit configured to:
receive a digital user visual content object from a user;
obtain a template e-book, the template e-book including at least one digital e-book content object, the digital e-book content object appearing in a plurality of pages included in the template e-book; and
generate a personalized e-book by replacing at least a portion of the digital e-book content object with the digital user visual content object in at least some of the plurality of pages.

17. The system of claim 16, wherein the user visual content object is an image of a face, and wherein the e-book modification unit is configured to:
receive from the user a marking of the face in the image and remove background information from the image to generate a modified image that only includes the face; and
store, on the server, the modified image of the face in association with an account of the user.

18. The system of claim 17, wherein the template e-book includes an indication of a location of a face of a character in a story and wherein the e-book modification unit is configured to replace a face of the character with the face in the image according to the indication of the location.

19. The system of claim 18, wherein the character in the template e-book is a headless character, the headless character includes a mark of the center of the neck of the headless character, and wherein the e-book modification unit is configured to attach an image of the face of the user to the headless character based on the mark.

20. The system of claim 17, wherein the e-book modification unit is configured to generate the personalized e-book based on metadata associated with the template e-book, the metadata including an indication of at least one of: an orientation of a face of a character, an expression, an angle and a cartoon style.
